(19) United States
(12) Patent Application Publication
(10) Pub. No.: US 2016/0056422 A1
(43) Pub. Date: Feb. 25, 2016

(54) Method for producing a casting for a battery cell

(71) Applicant: MANZ AG, REUTLINGEN (DE)

(72) Inventor: Martin Schaupp, ENINGEN (DE)

(21) Appl. No.: 14/830,912

(22) Filed: Aug. 20, 2015

(30) Foreign Application Priority Data
Aug. 22, 2014 (DE) 102014112080.9

(51) Int. Cl. H01M 2/02; H01M 2/36

(52) U.S. Cl. CPC H01M 2/0287; H01M 2/368

(57) ABSTRACT

A method for producing a casing for a battery cell that features a cell body with an electrode stack of several alternately arranged anodes and cathodes separated using separators includes that a coating, which mechanically protects the cell body, is at least sectionally applied onto the finished cell body and forms the casing.

### CROSS-REFERENCE TO A RELATED APPLICATION

The invention described and claimed hereinbelow is also described in German Patent Application DE 10 2014 112 080.9, filed on Aug. 22, 2014. The German Patent Application, the subject matters of which is incorporated herein by reference, provides the basis for a claim of priority of invention under 35 U.S.C. 119(a)-(d).

### BACKGROUND OF THE INVENTION

The invention relates to a method for producing a casing or packaging for a battery cell that features a cell body with an electrode stack of several alternately arranged anodes and cathodes separated by separators. The electrode stack also may be wound or folded. Furthermore, the electrode stack may also be produced galvanically. The casing or packaging is required for accommodating the typically liquid electrolyte in the cell. The casing also protects the cell from mechanical stresses and makes it possible to assemble several cells into a battery pack.

Until now, the casings were typically produced of molded parts, wherein the molded parts are manufactured of plastic sheets by swaging. Such a package is described, for example, in DE 10 2009 005 498 A1. A swaging die adapted to the shape of the cell body must be provided at least for one molded part. In a few production methods, heat-sealing dies adapted to the shape of the cell also must be used for closing packages produced of several molded parts.

The shapes of today's batteries are becoming more and more complex. However, a molded part cannot be manufactured of a plastic sheet by swaging for any arbitrary shape of the cell body because the elasticity and the ductility of a plastic sheet are limited. In addition, separate cost-intensive production lines for the casing must be respectively provided for differently shaped galvanic cells.

### SUMMARY OF THE INVENTION

The present invention overcomes the shortcomings of known arts, such as those mentioned above.

To that end, the present invention provides a method for producing a casing for a battery cell, by which battery cells with complicated shapes can be cost-efficiently provided with a casing.

In an embodiment, the method for producing a casing for a battery cell that features a cell body with an electrode stack of several alternately arranged anodes and cathodes separated by separators is characterized in that a coating, which mechanically protects the cell body, is at least sectionally applied onto the finished cell body and forms the casing.

The coating is applied onto an arbitrarily shaped cell body in an accurately fitted fashion. No expensive swaging dies that are adapted to the shape of the cell body or other tools that are dependent on the shape of the cell body are required for this purpose. The coating protects the electrode stack from external influences and damages and accommodates the electrolyte of the cell. The contact terminals of the cell protrude outward through the coating, i.e., they can be left open during the application of the coating onto the cell body.

Cell bodies with different geometries also are provided with a coating on one production line. In this case, the potential cell geometries are virtually unlimited. The casing in the form of a coating furthermore has a minimal space requirement such that the entire installation space for the battery cell in a device can be utilized for the cell body.

In an embodiment, a coating consisting of at least three layers is applied onto the cell body, wherein each of the layers may have a multilayered structure. In this case, the innermost layer may be produced of a material that prevents the admission of the coating materials into the electrode stack. The electrode layers cannot be penetrated by the applied coating materials. The innermost layer therefore represents a sealing layer that seals the individual electrode layers relative to one another.

Another layer is advantageously produced of a material that is impervious to the electrolyte to be subsequently filled into the cell, as well as impervious to gases. This layer forms a barrier layer in order to ensure that the gases being created cannot escape from the casing.

A third layer, preferably the outermost layer, is produced of a material that withstands mechanical stresses and therefore ensures the required protection of the cell body against shocks and scratches.

The different layers are applied in one processing step or in succession. The coating is applied by suitable chemical, mechanical, thermal or thermomechanical processes. The coating is preferably applied onto the cell body, for example, by spraying, dipping in an immersion bath and/or chemical deposition. If the coating consists of several layers, the individual layers also are applied by different processes.

Other advantages are attained if a check valve for subsequently introducing an electrolyte is integrated into the casing during the application of the coating. The check valve is thereby cast into the coating. However, the check valve also could form part of a cover construction that is attached onto the cell body after it was provided with a casing in accordance with an inventive method on the sides not covered by the cover construction.

The invention also provides a battery cell with a cell body that features an electrode stack of several alternately arranged anodes and cathodes separated by separators and is at least partially provided with a casing. The battery cell is characterized in that the casing is formed by a coating applied onto the cell body. In comparison with battery cells that feature packagings made of a plastic sheet, the casing of the inventive cell has a space-saving design because welded edges between individual molded parts are not required for a casing in the form of a coating. In addition, the casing of the inventive cell can be produced much cheaper than the packages of known cells.

The electrode stack also may be wound or folded in order to produce cylindrical or other geometric cell body shapes. The coating is preferably composed of at least three layers. In this case, the different layers fulfill the functions of a sealing layer, a barrier layer for gases being created in the cell and a mechanical protection layer. It also is possible to apply additional layers such as, in particular, a colored cover layer. With respect to the further handling of the battery cell, it is particularly advantageous if the coating at least partially consists of a material that cures in a dimensionally stable fashion. In this case, the casing forms a rigid housing of sorts around the cell body.

The cell also may feature a check valve for an electrolyte, through which the electrolyte is subsequently introduced.

### BRIEF DESCRIPTION OF THE DRAWINGS

Preferred variations of the method for producing a casing for a battery cell, as well as exemplary embodiments of inventive battery cells, are described in greater detail below with reference to the drawings, wherein:

FIG. 1a presents a schematic illustration of a first phase of the application of a coating onto a cell body of a battery cell according to the invention;

FIG. 1b presents a schematic illustration of a second phase of the application of a coating onto a cell body of a battery cell according to the invention;

FIG. 1c presents a schematic illustration of a third phase of the application of a coating onto a cell body of a battery cell according to the invention;

FIG. 2 presents a schematic illustration of a second battery cell with casing;

FIG. 3 presents a schematic illustration of the application of a coating layer by spraying; and

FIG. 4 presents a schematic illustration of the application of a coating by means of dipping in an immersion bath.

### DETAILED DESCRIPTION OF THE PREFERRED EMBODIMENTS

The following is a detailed description of example embodiments of the invention depicted in the accompanying drawings. The example embodiments are presented in such detail as to clearly communicate the invention and are designed to make such embodiments obvious to a person of ordinary skill in the art. However, the amount of detail offered is not intended to limit the anticipated variations of embodiments; on the contrary, the intention is to cover all modifications, equivalents, and alternatives falling within the spirit and scope of the present invention, as defined by the appended claims.

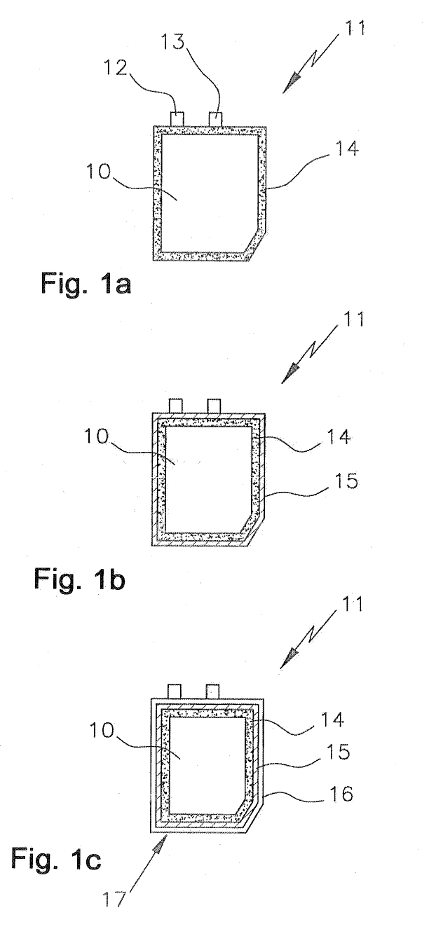

FIG. 1a schematically shows a cell body 10 for a battery cell 11 being produced. The cell body features an electrode stack that consists of anodes, cathodes and separators, which separators respectively are alternately stacked on top of one another. The anodes are connected to one another and to a first contact terminal 12 of the cell body 10. The cathodes are analogously connected to a second contact terminal 13. In order to protect the cell body 10 and to accommodate an electrolyte to be subsequently filled into the cell 11, the cell body is provided with a casing 17 (FIG. 1c) that consists of a multilayered coating of the cell body 10. For this purpose, a first layer 14 in the form of a sealing layer is initially applied onto the cell body in the step illustrated in FIG. 1a and prevents the admission of coating material into the cell body 10.

Subsequently, another layer 15 in the form of a barrier layer for gases being created in the cell 11, as well as for the electrolyte, is applied in as step illustrated in FIG. 1b. In the example shown, a third layer 16 in the form of a cover layer protecting the cell body from mechanical stresses is ultimately applied in a step illustrated in FIG. 1c.

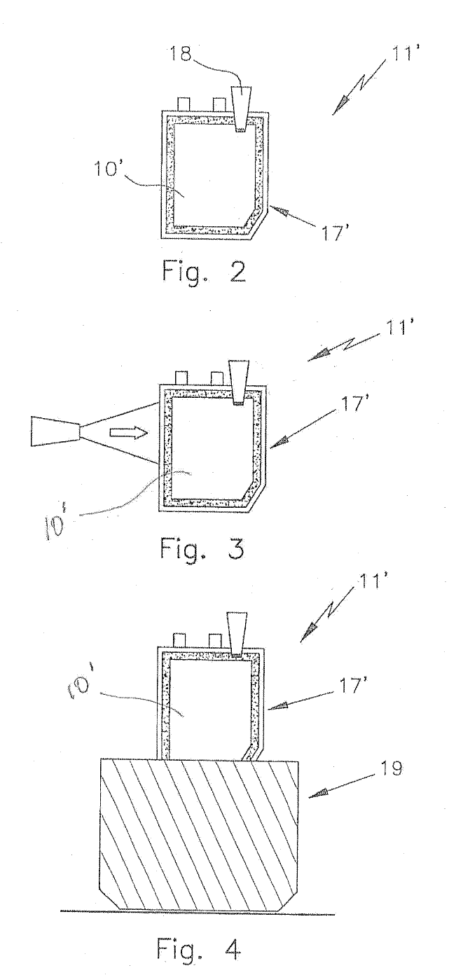

FIG. 2 shows an alternative embodiment of a battery cell 11′ that is provided with an additional check valve 18 for the electrolyte to be subsequently filled into the cell. The check valve can be cast into the casing 17′ during the application onto the cell body 10′.

FIG. 3 shows a first option for applying the casing 17′. In this case, the individual layers of the casing 17′ realized in the form of a coating of the cell body 10′ are applied onto the cell body 10′ by a spraying process.

FIG. 4 shows an alternative option for applying the layers of the casing 17′. In this case, the cell body 10′ is dipped into an immersion bath 19 of liquid layer material.

As will be evident to persons skilled in the art, the foregoing detailed description and figures are presented as examples of the invention, and that variations are contemplated that do not depart from the fair scope of the teachings and descriptions set forth in this disclosure. The foregoing is not intended to limit what has been invented, except to the extent that the following claims so limit that.

What is claimed is:

1. A method tor producing a casing for a battery cell that features a cell body with an electrode stack of several alternately arranged anodes and cathodes separated by separators, the method comprising steps of:
at least sectionally applying a coating onto the cell body to form the casing;
wherein the coating mechanically protects the cell body.

2. The method according to claim 1, wherein the step of at least sectionally applying requires applying at least three layers onto the cell body to form the coating.

3. The method according to claim 2, wherein an innermost layer of the at least three layers is produced of a material that prevents an admission of the coating materials into the electrode stack.

4. The method according to claim 2, wherein one of the at least three layers is produced of a material that is impervious to an electrolyte to be subsequently filled into the cell, impervious to gases or both.

5. The method according to claim 2, wherein one of the at least three layers is produced of a material that withstands mechanical stresses.

6. The method according to claim 2, wherein the at least three layers are applied successively.

7. The method according to claim 1, wherein the step of at least sectionally applying includes applying the coating by chemical, mechanical, thermal or thermomechanical processes.

8. The method according to claim 7, wherein the step of at least sectionally applying includes applying the coating by one or more of the group of spraying, dipping in an immersion bath and chemical deposition.

9. The method according to claim 1, further including a step of integrating a check valve into the casing for subsequently introducing an electrolyte during the step of at least sectionally applying the coating.

10. A battery cell, comprising:
a cell body including an electrode stack of several alternately arranged anodes and cathodes separated by separators; and
a casing at least partially provided on the cell body formed by applying a coating onto the cell body.

11. The battery cell according to claim 10, wherein the coating consists of at least three layers.

12. The battery cell according to claim 10, wherein the coating at least partially consists of a material that cures in a dimensionally stable fashion.

13. The battery cell according to claim 10, further comprising a check valve for an electrolyte.
